(19) United States
(12) Patent Application Publication
(10) Pub. No.: US 2008/0162869 A1
(43) Pub. Date: Jul. 3, 2008

(54) Address hashing to help distribute accesses across portions of destructive read cache memory

(75) Inventors: Nam Sung Kim, Portland, OR (US); Muhammad M. Khellah, Tigard, OR (US); Vivek De, Beaverton, OR (US)

Correspondence Address: INTEL/BLAKELY, 1279 OAKMEAD PARKWAY, SUNNYVALE, CA, 94085-4040, US

(73) Assignee: INTEL CORPORATION

(21) Appl. No.: 11/648,297

(22) Filed: Dec. 29, 2006

(51) Int. Cl. G06F 12/02

(52) U.S. Cl. 711/216

(57) ABSTRACT

For one disclosed embodiment, an apparatus may comprise cache memory circuitry including multiple portions of destructive read memory cells and access control circuitry to access portions of destructive read memory cells. The apparatus may also comprise address hash logic to receive an address and to generate a hashed address based at least in part on at least a portion of the received address using a hashing technique to help distribute accesses by the access control circuitry across different portions of destructive read memory cells. Other embodiments are also disclosed.

### RELATED APPLICATION(S)

This patent application discloses technology related to that disclosed in U.S. patent application Ser. No. 11/172,078, filed Jun. 29, 2005, entitled MEMORY CIRCUIT, by Muhammad M. Khellah, Dinesh Somasekhar, Yibin Ye, and Vivek K. De.

### FIELD

Embodiments described herein generally relate to memory.

### BACKGROUND

FIG. 1 illustrates circuitry for a prior art six transistor (6T) memory cell 1 for a static random access memory (SRAM). As illustrated in FIG. 1, memory cell 1 has two cross-coupled inverters 10 and 20 coupled between a supply voltage V_{SUPPLY} node and a ground node to generate complementary signals at storage nodes 11 and 21. Inverter 10 has a pull-up p-channel field effect transistor (PFET) 12 and a pull-down n-channel FET (NFET) 14. The gates of PFET 12 and NFET 14 are both coupled to receive a signal at storage node 21 to generate an inverted signal at storage node 11. Similarly, inverter 20 has a pull-up PFET 22 and a pull-down NFET 24. The gates of PFET 22 and NFET 24 are both coupled to receive a signal at storage node 11 to generate an inverted signal at storage node 21. The complementary signals at storage nodes 11 and 21 represent a single bit value depending on which signal is at which storage node 11 or 21.

Memory cell 1 also has NFETs 16 and 26 to access memory cell 1 to read a bit value from and/or write a bit value to memory cell 1. The gate of NFET 16 is coupled to receive a signal on a word line 30 to couple storage node 11 to a bit line 31. The gate of NFET 26 is coupled to receive a signal on word line 30 to couple storage node 21 to a bit line 32. Memory cell 1 may then be accessed by sensing the complementary signals on bit lines 31 and 32 to read the bit value stored by memory cell 1 or by asserting complementary signals on bit lines 31 and 32 to write a bit value to memory cell 1. NFETs 16 and 26 are known as transfer, access, or pass transistors.

To speed reading the bit value, PFETs 41, 42, and 43 are activated in response to a signal on a precharge line 40 to precharge bit lines 31 and 32 by coupling them to a supply voltage V_{SUPPLY} node. The bit value may then be read as soon as bit line 31 is pulled down by NFET pair 14 and 16 or bit line 32 is pulled down by NFET pair 24 and 26 without having to wait for the other bit line 32 or 31 to be pulled up.

Memory cell 1 may be designed to help meet a desired level of stability for a given memory size and process to help improve manufacturing yield. Memory cell 1 may be designed, for example, to account for mismatch in threshold voltage Vth of neighboring transistors as such mismatch reduces stability. As transistor dimensions are scaled, accounting for threshold voltage mismatch can prove challenging as the variability in the number and location of channel dopant atoms can result in restrictive electrical deviations in transistor threshold voltages Vth.

Read stability can be loosely defined as the probability that memory cell 1 will retain its stored bit value during a read operation. Memory cell 1 is more susceptible to noise during a read operation because the voltage at the low storage node, such as storage node 21 for example, will rise due to the voltage division by neighboring NFETs 24 and 26 between precharged bit line 32 and the ground node when NFET 26 is activated. Read stability is therefore generally proportional to the ratio of the transconductance of NFET 24 relative to that of NFET 26.

Write stability can be loosely defined as the probability that memory cell 1 will be written with an intended bit value during a write operation. Because a write is performed by discharging the voltage at the high storage node, such as storage node 21 for example, through NFET 26, write stability is generally proportional to the ratio of the transconductance of NFET 26 relative to that of PFET 22.

Example ways to improve stability of memory cell 1 include (1) sizing pull-down NFET 14 and 24 to have an increased width at the expense of increased cell area and reduced write stability, (2) sizing access NFET 16 and 26 to have a larger channel length at the expense of reduced read current and therefore reduced read operation speed, (3) using a separate, increased supply voltage V_{SUPPLY} at the expense of additional circuitry and increased power consumption and/or heat, and/or (4) adding a scalable negative supply voltage generator at the expense of additional circuitry to drive the source of pull-down NFET 14 and 24 to a negative voltage before word line 30 is activated to increase the strength of pull-down NFET 14 and 24.

### BRIEF DESCRIPTION OF THE DRAWINGS

Embodiments are illustrated by way of example and not limitation in the figures of the accompanying drawings, in which like references indicate similar elements and in which:

FIG. 1 illustrates circuitry for a prior art six transistor (6T) memory cell for a static random access memory (SRAM);

FIG. 2 illustrates, for one embodiment, a block diagram of an integrated circuit having address hash logic to help distribute accesses across different portions of destructive read cache memory cells;

FIG. 3 illustrates, for one embodiment, a flow diagram to help distribute accesses across different portions of destructive read cache memory cells;

FIG. 4 illustrates, for one embodiment, one example hashing technique to help distribute accesses across different portions of destructive read cache memory cells;

FIG. 5 illustrates, for one embodiment, one example hashing technique to help distribute accesses across different portions of destructive read cache memory cells;

FIG. 6 illustrates, for one embodiment, example circuitry to help access a destructive read memory cell with a write-back operation;

FIG. 7 illustrates, for one embodiment, a timing diagram for an access of a destructive read memory cell with a write-back operation; and

FIG. 8 illustrates, for one embodiment, a block diagram of an example system comprising a processor having address hash logic to help distribute accesses across different portions of destructive read cache memory cells.

The figures of the drawings are not necessarily drawn to scale.

### DETAILED DESCRIPTION

The following detailed description sets forth example embodiments of apparatuses, methods, and systems relating to address hashing to help distribute accesses across portions of destructive read cache memory. Features, such as structure(s), function(s), and/or characteristic(s) for example, are described with reference to one embodiment as a matter of convenience; various embodiments may be implemented with any suitable one or more described features.

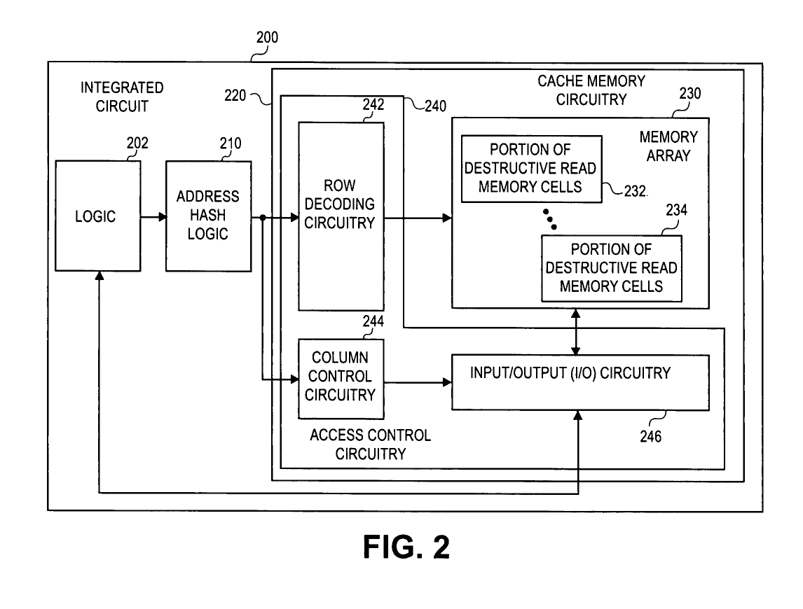

FIG. 2 illustrates, for one embodiment, an integrated circuit 200 having address hash logic 210 to help distribute accesses across portions of destructive read cache memory.

Integrated circuit 200 for one embodiment, as illustrated in FIG. 2, may include cache memory circuitry 220 that includes a memory array 230 and access control circuitry 240. Memory array 230 may have multiple portions of destructive read memory cells, such as portions 232 and 234 of destructive read memory cells. Access control circuitry 240 may be coupled to memory array 230 to access portions of destructive read memory cells. Access control circuitry 240 for one embodiment may access portions of destructive read memory cells in response to requests from logic 202. Logic 202 for one embodiment, as illustrated in FIG. 2, may be part of integrated circuit 200. Logic 202 for another embodiment may be external to integrated circuit 200.

Address hash logic 210 for one embodiment may be coupled to receive an address from logic 202 to generate a hashed address based at least in part on at least a portion of the received address using a hashing technique. Address hash logic 210 for one embodiment may be coupled to output the hashed address to access control circuitry 240 to access one portion of destructive read memory cells based at least in part on the hashed address. Address hash logic 210 for one embodiment may use the hashing technique to help distribute accesses by access control circuitry 240 across different portions of destructive read memory cells.

Distributing accesses across different portions of destructive read memory cells for one embodiment may help reduce or avoid successive accesses to the same portion of destructive read memory cells and may therefore help allow access control circuitry 240 to overlap in time accesses to memory array 230, helping to decrease cache memory access time. Access control circuitry 240 for one embodiment may access different portions of destructive read memory cells such that accesses to different portions of destructive read memory cells overlap in time. Access control circuitry 240 for one embodiment may access a first portion of destructive read memory cells for a first request and then initiate access of a second, different portion of destructive read memory cells for a second request prior to completing access for the first request.

Access control circuitry 240 for one embodiment may access different portions of destructive read memory cells such that access to one portion of destructive read memory cells overlaps in time with a write-back operation for an access to another portion of destructive read memory cells. Access control circuitry 240 for one embodiment may access a first portion of destructive read memory cells for a first request and then initiate access of a second, different portion of destructive read memory cells for a second request during a write-back operation that is to write data read from memory cells of the first portion back to those same memory cells. Distributing accesses across different portions of destructive read memory cells for one embodiment may therefore help allow access control circuitry 240 to help hide write-back operations and therefore help decrease cache memory access time.

One or more portions of destructive read memory cells for memory array 230 for one embodiment may include any suitable circuitry to implement any suitable destructive read memory cells to store data in any suitable manner. One or more portions of destructive read memory cells for memory array 230 for one embodiment may include any suitable circuitry for an array of any suitable number of destructive read memory cells logically arranged in any suitable number of rows and any suitable number of columns. A portion of destructive read memory cells for memory array 230 may correspond to any suitable portion of memory array 230, such as a sub-array, a bank, or a sub-bank for example.

One or more destructive read memory cells for one embodiment may include any suitable circuitry to store one or more signals representative of one bit value. One or more destructive read memory cells for one embodiment may include any suitable circuitry to implement any suitable destructive read static random access memory (DR-SRAM) cell. One or more destructive read memory cells for one embodiment may include any suitable circuitry to implement any suitable six transistor (6T) DR-SRAM cell. One or more destructive read memory cells for one embodiment may include any suitable circuitry to implement any suitable DR-SRAM cell, for example, to help avoid having to perform a data refresh operation during standby. One or more destructive read memory cells for one embodiment may be designed with a unity beta ratio where devices are substantially equally sized with relatively less or minimal geometry.

Circuitry to implement destructive read memory cells for one embodiment may be used for memory array 230 to account for cell instability. That is, a memory cell may be accessed for a read request by reading a bit value from the memory cell and then writing the read bit value back to the memory cell to correct for the possibility that the memory cell may not have retained its bit value due to the read. Memory array 230 for one embodiment may then be implemented with relatively reduced concern for cell stability. Memory array 230 for one embodiment may therefore be designed with relatively denser memory cells, with relatively less circuitry, and/or with relatively less power consumption.

Access control circuitry 240 may include any suitable circuitry coupled to access portions of destructive read memory cells of memory array 230 in any suitable manner. Access control circuitry 240 for one embodiment may be coupled to receive address signals from address hash logic 210, may be coupled to receive one or more control signals from logic 202, for example, and may be coupled to receive data signals from and/or transmit data signals to logic 202, for example. Access control circuitry 240 for one embodiment may receive address signals to identify one or more memory cells from which data is to be read and optionally returned or to which data is to be written. Access control circuitry 240 for one embodiment may receive one or more control signals to identify whether data is to be written to or read from memory cells.

Access control circuitry 240 for one embodiment, as illustrated in FIG. 2, may include row decoding circuitry 242, column control circuitry 244, and input/output (I/O) circuitry 246.

Row decoding circuitry 242 for one embodiment may be coupled to receive at least a portion of an address from address hash logic 210 and to assert a signal on a word line to select memory cells in a row of one portion of destructive read memory cells in response to the received address or address portion. Row decoding circuitry 242 for one embodiment may be coupled to receive from address hash logic 210 at least a portion index address field of an address to help identify a portion of destructive read memory cells to be accessed. Column control circuitry 244 for one embodiment may be coupled to receive at least a portion of the address from address hash logic 210 and to assert one or more signals on one or more column select lines to select memory cells in columns of one or more portions of destructive read memory cells in response to the received address or address portion. Column control circuitry 244 for one embodiment may assert signal(s) on column select line(s) to control multiplexers of I/O circuitry 246 to select columns and output data stored by memory cells in both a row selected by row decoding circuitry 242 and selected columns.

I/O circuitry 246 for one embodiment may include precharge circuitry coupled to precharge bit lines coupled to memory cells in columns. I/O circuitry 246 for one embodiment may include sensing circuitry, such as sense amplifiers for example, coupled to sense on bit lines corresponding to selected columns of memory cells signals representative of bit values from memory cells in a selected row and to output signals corresponding to the sensed signals. I/O circuitry 246 for one embodiment may include write drivers coupled to receive from logic 202, for example, signals representative of bit values and to assert corresponding signals on bit lines corresponding to selected columns of memory cells to write to memory cells in a selected row.

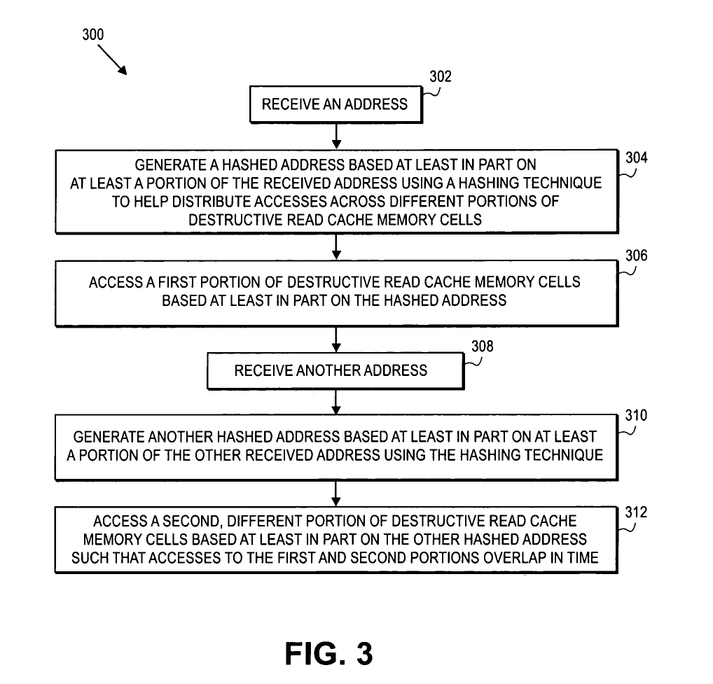

FIG. 3 illustrates, for one embodiment, a flow diagram 300 to help distribute accesses across different portions of destructive read cache memory cells. Address hash logic 210 for block 302 may receive an address and for block 304 may generate a hashed address based at least in part on at least a portion of the received address using a hashing technique to help distribute accesses across different portions of destructive read cache memory cells. Access control circuitry 240 for block 306 may access a first portion of destructive read cache memory cells based at least in part on the hashed address. Address hash logic 210 for block 308 may receive another address and for block 310 may generate another hashed address based at least in part on at least a portion of the other received address using the hashing technique. Access control circuitry 240 for block 312 may access a second, different portion of destructive read cache memory cells based at least in part on the other hashed address such that accesses to the first and second portions overlap in time.

Accessing the first portion of destructive read cache memory cells for one embodiment for block 306 may include writing read data back to accessed destructive read cache memory cells. Accessing the second portion of destructive read cache memory cells for one embodiment for block 312 may overlap in time with writing read data back to accessed destructive read cache memory cells for block 306.

Example Address Hash Logic

Address hash logic 210 may be implemented in any suitable manner to generate a hashed address based at least in part on at least any suitable portion of a received address using any suitable hashing technique that helps distribute accesses by access control circuitry 240 across different portions of destructive read memory cells. The hashing technique for one embodiment may include an exclusive-or (XOR) operation. Address hash logic 210 for one embodiment may be implemented using any suitable hard-wired logic to generate a hashed address using any suitable hashing technique. Address hash logic 210 for one embodiment may be implemented using programmable logic responsive, for example, to software and/or firmware instructions to generate a hashed address using any suitable hashing technique.

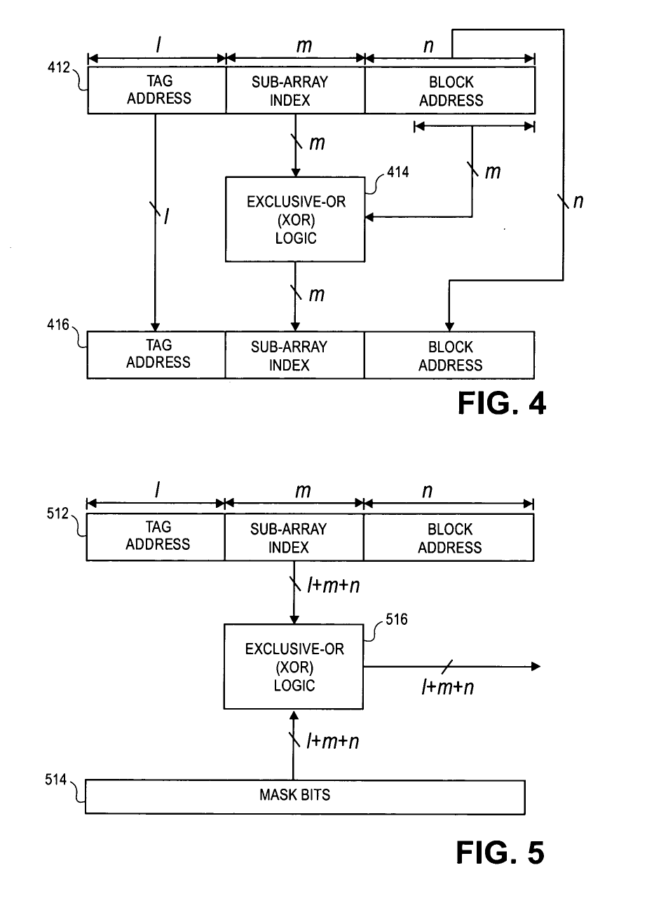

Address hash logic 210 for one embodiment may generate a hashed address based at least in part on any suitable first set of bits of a received address and any suitable second set of bits of the received address. Address hash logic 210 for one embodiment may generate a hashed address based at least in part on any suitable bits of a portion index field of a received address and any suitable bits from another field of the received address, such as an offset field for example. For one embodiment where portions of destructive read memory cells correspond to sub-arrays of memory array 230, address hash logic 210 for one embodiment, as illustrated in FIG. 4, may generate a hashed address based at least in part on a sub-array index field of a received address and a portion of a block address field of the received address.

As illustrated in FIG. 4, address hash logic 210 for one embodiment may include a receive address register 412, exclusive-or (XOR) logic 414, and a hashed address register 416. Receive address register 412 may be coupled to receive and store an address from logic 202, for example.

XOR logic 414 for one embodiment, as illustrated in FIG. 4, may be coupled to perform an XOR operation on respective bits of m bits of a sub-array index field of a received address and m least significant bits of a block address field of the received address to generate m bits for a sub-array index field of a hashed address. Hashed address register 416 for one embodiment may be coupled to receive the generated m bits for the sub-array index field and remaining corresponding bits of the received address to receive and store a hashed address. Hashed address register 416 for one embodiment, as illustrated in FIG. 4, may be coupled to receive the generated m bits for the sub-array index field, 1 bits of a tag address field from receive address register 412, and n bits of a block address field from receive address register 412. Address hash logic 210 for one embodiment may not have hashed address register 416 but rather may output bits for a hashed address from receive address register 412 and XOR logic 414.

Address hash logic 210 for one embodiment may generate a hashed address based at least in part on any suitable bits of a received address and any suitable mask bits. Address hash logic 210 for one embodiment may generate a hashed address based at least in part on bits of a portion of a received address and mask bits. Address hash logic 210 for one embodiment may generate a hashed address based at least in part on bits of all of a received address and mask bits. Address hash logic 210 for one embodiment may include a register coupled to receive and store mask bits from logic 202, for example. Mask bits for one embodiment may be programmable to allow access patterns to be defined and changed in any suitable manner. Address hash logic 210 for one embodiment, as illustrated in FIG. 5, may generate a hashed address based on the bits of the received address and mask bits.

As illustrated in FIG. 5, address hash logic 210 for one embodiment may include a receive address register 512, a mask register 514, and exclusive-or (XOR) logic 516. Receive address register 512 may be coupled to receive and store an address from logic 202, for example. Mask register 514 may be coupled to receive and store mask bits from logic 202, for example. XOR logic 516 for one embodiment, as illustrated in FIG. 5, may be coupled to perform an XOR operation on respective bits of the received address and the received mask bits to generate and output bits for a hashed address.

Example Destructive Read Memory Cells

Cache memory circuitry 220 may include any suitable circuitry to help access a destructive read memory cell with a write-back operation. As one example, cache memory circuitry 220 may include as part of I/O circuitry 246 sense amplifiers that include any suitable circuitry to sense a stored bit value from a destructive read memory cell and to write that bit value back to the same destructive read memory cell.

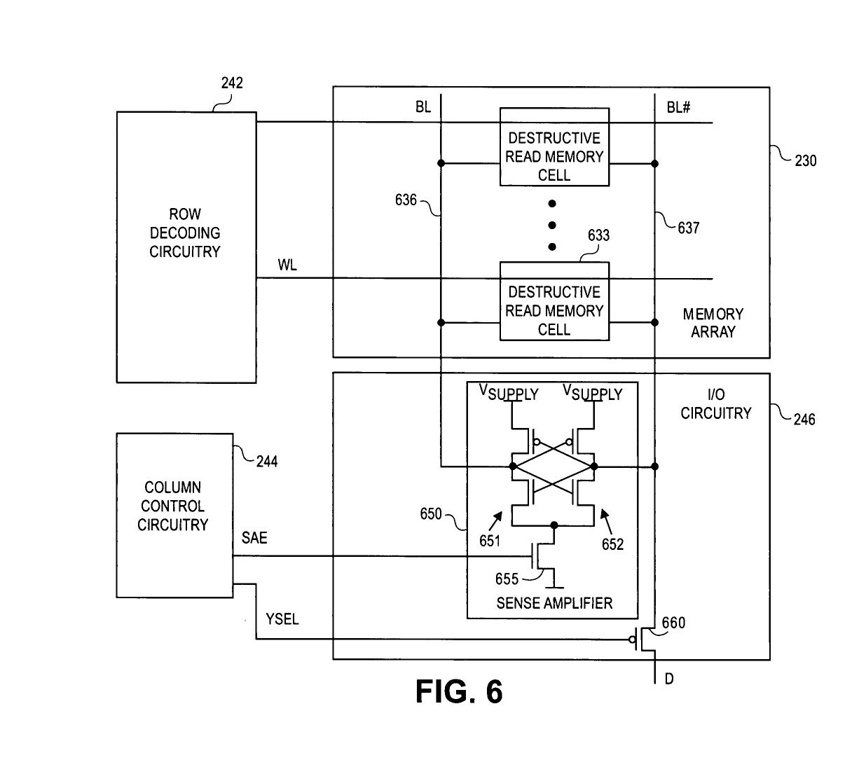

FIG. 6 illustrates, for one embodiment, an example sense amplifier 650 that forms a part of I/O circuitry 246 to access a destructive read memory cell in a column of destructive read memory cells that form a part of a portion of destructive read memory cells for memory array 230. Other circuitry, such as additional sense amplifiers for I/O circuitry 246 and additional columns of destructive read memory cells for memory array 230 for example, is not shown for convenience and clarity.

As illustrated in FIG. 6, sense amplifier 650 has two cross-coupled inverters 651 and 652 coupled between a supply voltage V_{SUPPLY} node and another supply voltage node, such as a ground node for example, and coupled to sense on bit lines 636 and 637 complementary bit line signals BL and BL# representative of a bit value stored by a selected destructive read memory cell, such as destructive read memory cell 633 for example. Destructive read memory cell 633 for one embodiment may be selected in response to assertion of a corresponding word line signal WL by row decoding circuitry 242 to read complementary signals MC/MC# stored by destructive read memory cell 633 onto bit lines 636 and 637 as complementary bit line signals BL and BL#. Sense amplifier 650 for one embodiment, as illustrated in FIG. 6, may be enabled to sense signals BL and BL# in response to assertion by column control circuitry 244 of a sense amplifier enable signal SAE to activate an enable transistor 655 coupled between cross-coupled inverters 651 and 652 and the other supply voltage node, for example. Cross-coupled inverters 651 and 652 may then store signals BL and BL#, allowing at least one of the sensed signals, such as bit line signal BL# for example, to be output as a data signal D to logic 202, for example, in response to assertion by column control circuitry 244 of a corresponding column select signal YSEL to activate a multiplexer transistor 660 coupled between a storage node defined by cross-coupled inverters 651 and 652 and a data signal line.

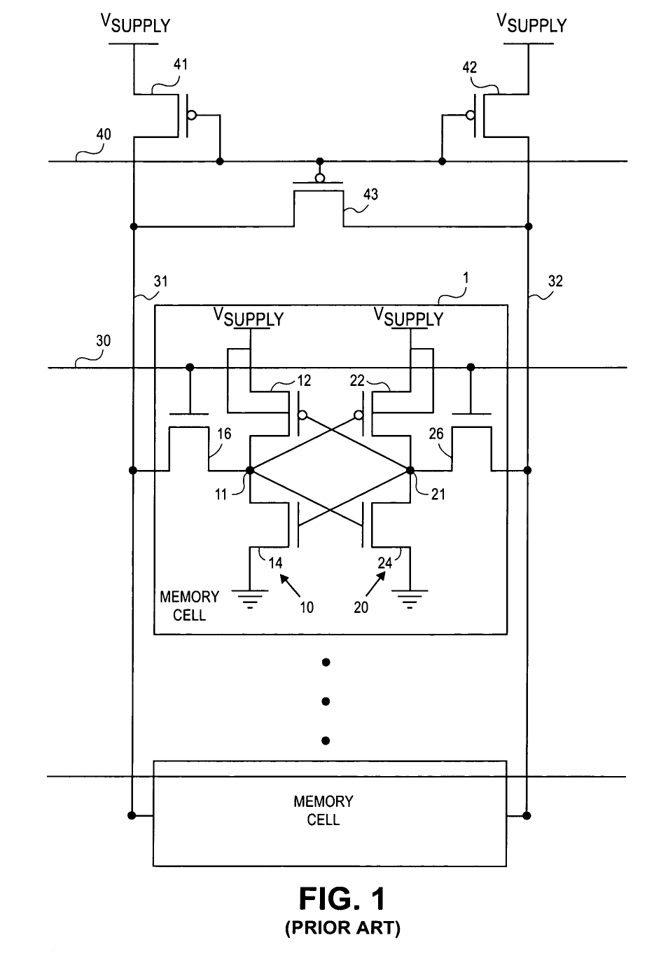

As a result of coupling destructive read memory cell 633 to bit lines 636 and 637, destructive read memory cell 633 may not retain its stored bit value. Destructive read memory cell 633 for one embodiment may be designed, for example, similarly as memory cell 1 of FIG. 1 with relatively reduced concern for cell stability. Sense amplifier 650, however, may be used to write the sensed bit value stored by sense amplifier 650 back to destructive read memory cell 633 by coupling sense amplifier 650 to destructive read memory cell 633 while selected.

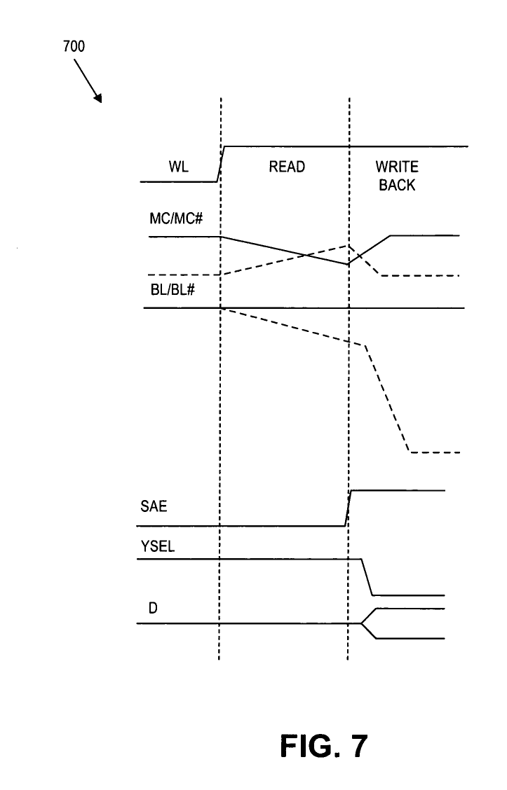

FIG. 7 illustrates, for one embodiment, an example timing diagram 700 for an access to destructive read memory cell 633, for example, with a write-back operation. As illustrated in FIG. 7, destructive read memory cell 633 may be accessed by assertion of a word line signal WL to couple destructive read memory cell 633 to precharged bit lines 636 and 637, causing one of the bit line signals BL or BL# to discharge based on the bit value represented by complementary signals MC/MC# stored by destructive read memory cell 633 and causing destructive read memory cell 633 to possibly lose its stored bit value. A sense amplifier enable signal SAE may then be asserted to enable sense amplifier 650 to sense bit line signals BL and BL# as well as to write the sensed bit line signals BL and BL# back to destructive read memory cell 633 while it remains selected by word line signal WL. A column select signal YSEL may be asserted to output a data signal D representative of the bit value stored by destructive read memory cell 633.

While selected destructive read memory cell 633 is being written back using sense amplifier 650, row decoding circuitry 242, column control circuitry 244, and I/O circuitry 246 for one embodiment may initiate access to a destructive read memory cell in a portion of memory array 230 different than a portion that includes destructive read memory cell 633. Row decoding circuitry 242, column control circuitry 244, and I/O circuitry 246 for one embodiment may initiate access to a destructive read memory cell of a portion that does not share word lines with the portion that includes destructive read memory cell 633. Row decoding circuitry 242, column control circuitry 244, and I/O circuitry 246 for one embodiment may initiate access to a destructive read memory cell of a portion that does not share sense amplifiers with the portion that includes destructive read memory cell 633.

Example System

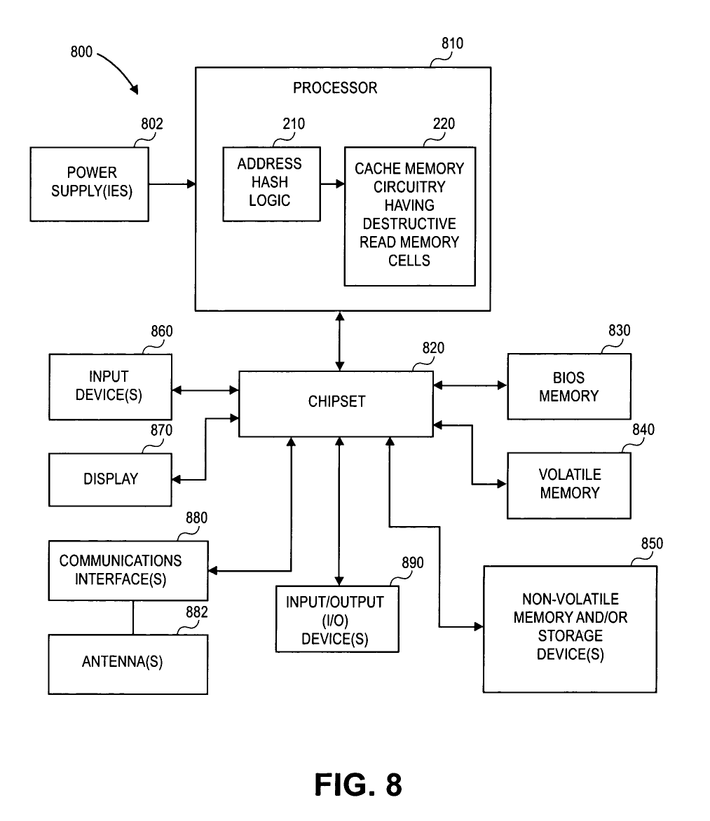

Integrated circuit 200 may be used in any suitable system. Integrated circuit 200 for one embodiment may correspond to an integrated circuit having address hash logic 210 and cache memory circuitry 220 for a processor 810 used in a system 800 as illustrated in FIG. 8. Integrated circuit 200 for one embodiment may also correspond to an integrated circuit for cache memory separate from processor 810. System 800 for another embodiment may include multiple processors one or more of which may have an integrated circuit having address hash logic 210 and cache memory circuitry 220.

Processor 810 for one embodiment may be coupled to receive power from one or more power supplies 802. Power supply(ies) 802 for one embodiment may include one or more energy cells, such as a battery and/or a fuel cell for example. Power supply(ies) 802 for one embodiment may include an alternating current to direct current (AC-DC) converter. Power supply(ies) 802 for one embodiment may include a DC-DC converter. Power supply(ies) 802 for one embodiment may include one or more voltage regulators to help supply power to processor 810.

System 800 for one embodiment may also include a chipset 820 coupled to processor 810, a basic input/output system (BIOS) memory 830 coupled to chipset 820, volatile memory 840 coupled to chipset 820, non-volatile memory and/or storage device(s) 850 coupled to chipset 820, one or more input devices 860 coupled to chipset 820, a display 870 coupled to chipset 820, one or more communications interfaces 880 coupled to chipset 820, and/or one or more other input/output (I/O) devices 890 coupled to chipset 820.

Chipset 820 for one embodiment may include any suitable interface controllers to provide for any suitable communications link to processor 810 and/or to any suitable device or component in communication with chipset 820.

Chipset 820 for one embodiment may include a firmware controller to provide an interface to BIOS memory 830. BIOS memory 830 may be used to store any suitable system and/or video BIOS software for system 800. BIOS memory 830 may include any suitable non-volatile memory, such as a suitable flash memory for example. BIOS memory 830 for one embodiment may alternatively be included in chipset 820.

Chipset 820 for one embodiment may include one or more memory controllers to provide an interface to volatile memory 840. Volatile memory 840 may be used to load and store data and/or instructions, for example, for system 800. Volatile memory 840 may include any suitable volatile memory, such as suitable dynamic random access memory (DRAM) for example. Processor 810 for one embodiment may use cache memory circuitry 220 to store data and/or instructions stored or to be stored in volatile memory 840, for example, for faster access to such data and/or instructions.

Chipset 820 for one embodiment may include a graphics controller to provide an interface to display 870. Display 870 may include any suitable display, such as a cathode ray tube (CRT) or a liquid crystal display (LCD) for example. The graphics controller for one embodiment may alternatively be external to chipset 820.

Chipset 820 for one embodiment may include one or more input/output (I/O) controllers to provide an interface to non-volatile memory and/or storage device(s) 850, input device(s) 860, communications interface(s) 880, and/or I/O devices 890.

Non-volatile memory and/or storage device(s) 850 may be used to store data and/or instructions, for example. Non-volatile memory and/or storage device(s) 850 may include any suitable non-volatile memory, such as flash memory for example, and/or may include any suitable non-volatile storage device(s), such as one or more hard disk drives (HDDs), one or more compact disc (CD) drives, and/or one or more digital versatile disc (DVD) drives for example.

Input device(s) 860 may include any suitable input device(s), such as a keyboard, a mouse, and/or any other suitable cursor control device.

Communications interface(s) 880 may provide an interface for system 800 to communicate over one or more networks and/or with any other suitable device. Communications interface(s) 880 may include any suitable hardware and/or firmware. Communications interface(s) 880 for one embodiment may include, for example, a network adapter, a wireless network adapter, a telephone modem, and/or a wireless modem. For wireless communications, communications interface(s) 880 for one embodiment may use one or more antennas 882.

I/O device(s) 890 may include any suitable I/O device(s) such as, for example, an audio device to help convert sound into corresponding digital signals and/or to help convert digital signals into corresponding sound, a camera, a camcorder, a printer, and/or a scanner.

Although described as residing in chipset 820, one or more controllers of chipset 820 may be integrated with processor 810, allowing processor 810 to communicate with one or more devices or components directly. As one example, one or more memory controllers for one embodiment may be integrated with processor 810, allowing processor 810 to communicate with volatile memory 840 directly.

In the foregoing description, example embodiments have been described. Various modifications and changes may be made to such embodiments without departing from the scope of the appended claims. The description and drawings are, accordingly, to be regarded in an illustrative rather than a restrictive sense.

What is claimed is:

1. An apparatus comprising:
cache memory circuitry including multiple portions of destructive read memory cells and access control circuitry to access portions of destructive read memory cells; and
address hash logic to receive an address and to generate a hashed address based at least in part on at least a portion of the received address using a hashing technique to help distribute accesses by the access control circuitry across different portions of destructive read memory cells.

2. The apparatus of claim 1, wherein the access control circuitry is to access different portions of destructive read memory cells such that accesses to different portions of destructive read memory cells overlap in time.

3. The apparatus of claim 1, wherein the access control circuitry is to access different portions of destructive read memory cells such that access to one portion of destructive read memory cells overlaps in time with a write-back operation for an access to another portion of destructive read memory cells.

4. The apparatus of claim 1, wherein the hashing technique includes an exclusive-or operation.

5. The apparatus of claim 1, wherein the address hash logic is to generate the hashed address based at least in part on a first set of bits of the received address and a second set of bits of the received address.

6. The apparatus of claim 1, wherein the address hash logic is to generate the hashed address based at least in part on bits of a portion index field of the received address and bits of another field of the received address.

7. The apparatus of claim 1, wherein the address hash logic is to generate the hashed address based at least in part on bits of the received address and mask bits.

8. The apparatus of claim 7, wherein the address hash logic includes a register to store mask bits.

9. The apparatus of claim 1, wherein the cache memory circuitry includes multiple portions of destructive read static random access memory cells.

10. A method comprising:
receiving an address;
generating a hashed address based at least in part on at least a portion of the received address using a hashing technique to help distribute accesses across different portions of destructive read cache memory cells; and
accessing a portion of destructive read cache memory cells based at least in part on the hashed address.

11. The method of claim 10, wherein the accessing is of a first portion of destructive read cache memory cells and wherein the method comprises:
receiving another address;
generating another hashed address based at least in part on at least a portion of the other received address using the hashing technique; and
accessing a second portion of destructive read cache memory cells based at least in part on the other hashed address such that accesses to the first and second portions of destructive read cache memory cells overlap in time.

12. The method of claim 11, wherein accessing the first portion of destructive read cache memory cells includes writing read data back to accessed destructive read cache memory cells and wherein accessing the second portion of destructive read cache memory cells overlaps in time with the writing.

13. The method of claim 10, wherein the hashing technique includes an exclusive-or operation.

14. The method of claim 10, wherein the generating includes generating the hashed address based at least in part on a first set of bits of the received address and a second set of bits of the received address.

15. The method of claim 10, wherein the generating includes generating the hashed address based at least in part on bits of a portion index field of the received address and bits of another field of the received address.

16. The method of claim 10, wherein the generating includes generating the hashed address based at least in part on bits of the received address and mask bits.

17. The method of claim 16, comprising storing mask bits in a register.

18. A system comprising:
volatile memory; and
a processor having cache memory circuitry including multiple portions of destructive read memory cells and access control circuitry to access portions of destructive read memory cells, the processor also having address hash logic to receive an address and to generate a hashed address based at least in part on at least a portion of the received address using a hashing technique to help distribute accesses by the access control circuitry across different portions of destructive read memory cells.

19. The system of claim 18, wherein the address hash logic is to generate the hashed address based at least in part on a first set of bits of the received address and a second set of bits of the received address.

20. The system of claim 18, wherein the address hash logic is to generate the hashed address based at least in part on bits of the received address and mask bits.
